(19) United States
(12) Patent Application Publication
(10) Pub. No.: US 2005/0246196 A1
(43) Pub. Date: Nov. 3, 2005

(54) Real-time behavior monitoring system

(76) Inventors: Didier Frantz, New York, NY (US); Ben Hugo Sloan Chesser, Barcelona (ES)

Correspondence Address: SCANBUY, INC., 54 WEST 39TH STREET, FOURTH FLOOR, NEW YORK, NY, 10018, US

(21) Appl. No.: 11/108,923

(22) Filed: Apr. 19, 2005

Related U.S. Application Data
(60) Provisional application No. 60/565,819, filed on Apr. 28, 2004.

(51) Int. Cl. G06F 17/60

(52) U.S. Cl. 705/1; 705/10

(57) ABSTRACT

The present invention discloses a behavior monitoring system and method for tracking users' consumer behavior in real-time. Each participant of the system is equipped with a mobile device capable of decoding barcodes. Every time a participant makes a purchase, they scan the barcode located on the product and answer preliminary questions about the product. This information is then sent to a server via a wireless network and stored in a user database. The participant is then prompted with a series of more specific questions once the scanned barcode has been identified using a product database. The answers to the additional questions are also stored in the user database.

### PARENT CASE TEXT

This application claims the benefit of provisional application No. 60/565,819 filed Apr. 28, 2004.

### FIELD OF THE INVENTION

The present invention relates generally to the field of consumer behavior monitoring. More specifically, the present invention utilizes barcode scanning and wireless technologies to provide a real-time monitoring system capable of tracking consumers' habits.

### BACKGROUND OF THE INVENTION

There currently exists many different ways of tracking and evaluating consumer behavior patterns. The most commonly utilized method is the survey. A survey is typically conducted by posing a general question to the public and soliciting responses. The survey can be targeted to a specific demographic or it can be utilized to track general consumer behavior for an entire population.

Generally, surveys are conducted by providing people with a form with questions. The questions typically contain a number of possible selections for answers. Some questions may also allow users to fill in individual answers. Each person in the survey fills out a form and returns it to a receiving office. The company or person that issued the survey must then compile the results using manual data entry once all of the forms have been received.

Surveys are also conducted over the telephone. For example, a company which manufactures vacuums may call users of its products to ask questions pertaining to the quality of the product, happiness with the product, etc. The person asking the user of the product questions typically enters in each of the participant's responses manually at a computer terminal. The results of telephone surveys provide valuable marketing information to the company and allow it to make more effective marketing decisions.

Telephone surveys may also be accomplished through interactive voice response systems (“IVR”). An IVR is a system which is programmed to provide voice prompts and accept input, either through voice response or through dual tone multiple frequency tones produced by a telephone keypad. For surveys, the IVR is pre-programmed with a series of questions to ask each user. The IVR contacts each person on a contact list and stores their responses in a database. An IVR system has the advantage that no manual data entry is required to input information.

However, in recent years, surveys have increasingly been conducted online. Online surveys have the advantage that the results can be compiled much more quickly and efficiently because a computer program can be utilized to compile the results.

Besides surveys, other methods of tracking consumer behavior have also become popular in recent years. One of the most common methods of doing this has been to retrofit existing consumer products with behavior tracking devices. For example, a certain percentage of the United States population (and many other countries) have devices attached to their televisions which track the viewing habits of the user's of the households. Each participant in this system first registers with the company that manages the behavior monitoring system. This information, along with the user's monitored viewing habits, is utilized to measure the success of different broadcasts and predict the future popularity of television shows.

With the advent of the Internet, similar methods have also been developed to track consumer's viewing habits. This is primarily done by “cookies” located on the user's computers. These files can be utilized to track many different types of information such as what websites a user visits, the frequency and length of visits, etc. However, many computer users do not enjoy having their Internet surfing habits tracked and see cookies as being obtrusive. Many people install programs which eliminate cookies and prevent their further occurrence.

Consumer opinion and behavior is also often gauged using “focus groups.” A focus group is a group of individuals which agree to test a new product and provide their input usually for some sort of compensation. Focus groups are utilized for a wide variety of purposes such as to measure the reactions of people to a movie prior to its release, to test a new product before it is placed on the national market, etc.

Based on the aforementioned different behavior monitoring methods, there clearly exits a need for a system capable of tracking the daily behavior of consumers which is not limited to a single product. The behavior monitoring system should be as unobtrusive as possible and minimally affect the life of the participants. Such a system would provide companies with valuable behavioral information currently not available through other means.

### SUMMARY OF THE INVENTION

The present invention provides a real-time behavior monitoring system designed to track user behavior through the use of commercially available barcodes and other machine-readable codes. The system operates by assigning each user a mobile device capable of scanning barcodes and/or other machine-readable codes. For scanning barcodes, the present invention is compatible with both laser-based scanning devices and devices which utilize optical decoding techniques. For example, optical decoding techniques capable of decoding barcodes from image are disclosed in U.S. patent application Ser. No. 10/757,095 entitled “System and Method for Decoding and Analyzing Barcodes Utilizing a Mobile Device” and U.S. Provisional Patent Application 60/511,703 entitled “Server-Side Decoding Process of Image.”

Prior to participating in the system of the present invention, each user must first register with the system by providing identification information. This can occur in a number of ways. First, a person may register by filling out a questionnaire and submitting it to the company in charge of the behavior monitoring system. The questionnaire may ask the user to provide personal identification information such as a first name, last name, social security number, address, telephone number, birth date, age, occupation, education, preferred method of contact, etc. Once the form is received by the company, the information from each user can be manually entered or scanned into a user database.

Participants can also register with the system of the present invention utilizing the telephone. In this method of registration, each user would be provided with a local or toll-free telephone number to call for registration. The telephone registration system may use an interactive voice response system to have a participant provide identification information. The user could either utilize the telephone keypad to enter information or the user could speak each entry.

Telephone registration may also be accomplished utilizing a live operator who asks the participant each question and manually enters the information into the user database.

Registration with the behavior monitoring system may also be accomplished by having participants visit a website and filling out a form on a website. The questions provided on the website would be similar to the questions provided on a printed questionnaire. Registering through a website has the advantage that the information from each user can be added to the user database in real-time and does not require manual data entry.

After a user has registered, he/she is ready to utilize the system of the present invention. For each product purchased by the user, the user first scans the machine readable code located on the product. Since the user is utilizing a mobile device to scan the barcode, the scanning can take place at virtually any location. For example, a user can scan products at a supermarket as they are placed into the user's shopping cart or directly after checkout. The user does not have to wait until he/she is at home to use the behavior monitoring system.

After a user scans the machine readable code located on the product, the user is then asked a few preliminary questions about the purchase by the mobile device. This information, along with a user identification number, is then sent to a central database which identifies the scanned product and user and provides more questions to the user specifically about the scanned product. These questions may be tailored based upon a wide range of criteria. For example, the additional questions may be altered based on the particular user's age, sex, occupation, etc. The questions may even be altered based upon the time of day, day of the week, month, etc. By altering the question in such a manner, the behavior monitoring system of the present invention may appear more interactive to the user and thus encourage further user participation.

The items which the user scans, as well as the user's answers to the provided questions, are stored real-time in a database. Such a system provides the company utilizing the system of the present invention with valuable marketing information about a user's purchasing behavior. Since the users' answers are stored in real-time in the database, the company has immediate access to this marketing information such as product purchased, quantity, price, place, etc.

Therefore, it is an object of the present invention to provide a behavior monitoring system which tracks users' behavior utilizing commonly available barcodes located on items of commerce.

Another object of the present invention is to provide a behavior monitoring system which is capable of tracking the real-time behavior of users.

An additional object of the present invention is to provide a behavior monitoring system which utilizes mobile devices to communicate information via a wireless communication network.

Yet another object of the present invention is to provide a behavior monitoring system which tracks the assorted spending habits of users.

Still another object of the present invention is to provide a behavior monitoring system which is capable of utilizing multiple barcode formats.

Yet another object of the present invention is to provide a behavior monitoring system which can be used at almost any location.

Another object of the present invention is to provide a behavior monitoring system which does not adversely affect or inconvenience the user.

An additional object of the present invention is to provide a behavior monitoring system which adapts questions to specific users and other criteria.

These and other objects of the present will be made clearer with reference to the following detailed description and accompanying drawings.

### BRIEF DESCRIPTION OF THE DRAWINGS

FIG. 1 depicts a schematic diagram of the network configuration utilized in the preferred embodiment of the invention.

FIG. 2 depicts a flowchart showing the steps utilized by a user to register with the behavior monitoring system via a website.

FIG. 3 depicts a flowchart showing the steps performed by the system of the present invention each time a barcode is scanned.

### DETAILED DESCRIPTION OF THE PREFERRED EMBODIMENT(S)

The following presents a detailed description of a preferred embodiment (as well as some alternative embodiments) of the present invention. However, it should be apparent to one skilled in the art that the described embodiment(s) may be modified in form and content to be optimized for a wide variety of situations.

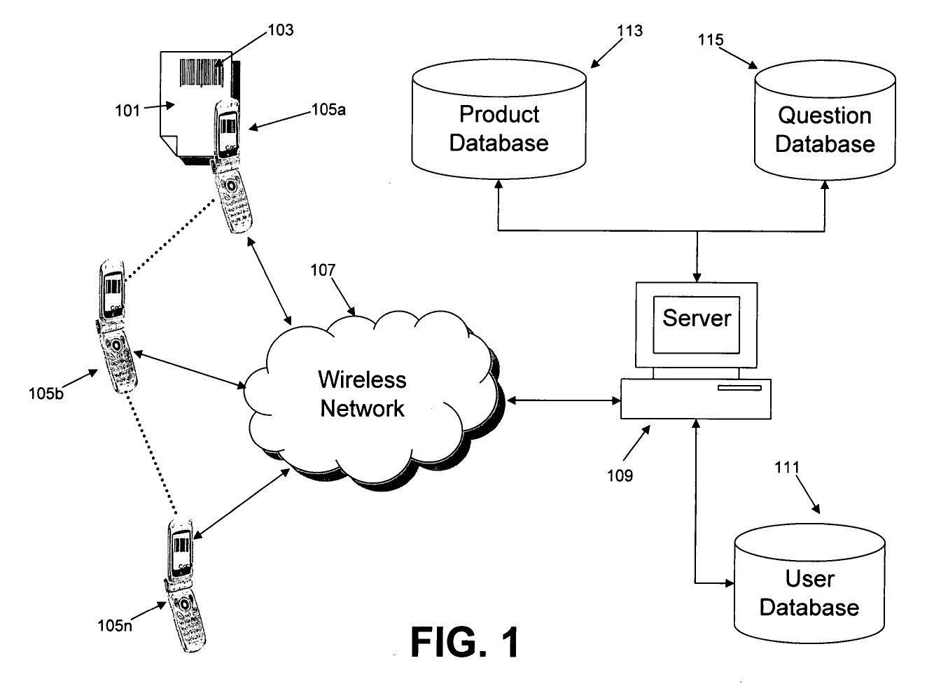

With reference first to FIG. 1, shown is a schematic diagram of the network configuration utilized in the preferred embodiment of the present invention. In this figure, product 101 contains machine readable code 103 which may be placed on product 101 in a variety of ways. For example, machine readable code 103 may be printed directly onto product 101 utilizing conventional printing techniques. Alternatively, machine readable code 103 may be affixed to product 101 utilizing a sticker, tag, etc.

Machine readable code 103 may be any code capable of being scanned by mobile device 105. In the preferred embodiment, machine readable code 103 is a barcode from any one or two-dimensional barcode symbology library. Some examples of one and two dimensional symbologies include, but are not limited to, UPC-A, UPC-E, ISBN, RSS-14, RSS-14E, RSS-14L, Interleaved 2 of 5, EAN/JAN-8, EAN/JAN-13, Code 39, Code 39 Full ASCII, Code 128, PDF417, QR Code, Data Matrix, and Optical Intelligence 2D.

Each user of the behavior monitoring system is equipped with one mobile device 105a-105n which is capable of scanning machine readable code 103. The present invention is compatible with both laser-based scanning mobile devices and mobile devices which utilize optical decoding techniques. For example, optical decoding techniques capable of decoding barcodes from image are disclosed in U.S. patent application Ser. No. 10/757,095 entitled “System and Method for Decoding and Analyzing Barcodes Utilizing a Mobile Device” and U.S. Provisional Application No. 60/511,703 entitled “Server-Side Decoding Process of Image.”

Mobile device 105 converts the machine readable code information into a string of characters which is recognizable by a computer. Once machine readable code 103 has been scanned, the user is initially asked a few questions such as “Quantity purchased?” or “Price?” These questions are standard questions which are asked to each user for every item scanned. However, it should be apparent to one skilled in the art that any number of questions may be asked.

Information from mobile devices 105a-105n is bi-directionally transmitted to server 109 via wireless network 107. In the preferred embodiment of the present invention, wireless network 107 is a cellular network. However, any wireless network (e.g., Bluetooth) or method of connecting devices wirelessly (e.g., infrared) may be utilized with the present invention. Since mobile device 105 communicates via wireless network 109, it can be utilized at any location where wireless network 109 is available.

Server 109 is primarily responsible for storing the users' personal identification information, scanned items, and answers to questions. Server 109 also provides specific questions to the user for each product scanned. Server 109 contains user database 111, product database 113, and question database 115. User database 111 stores each user's personal information, scanned items, and answers to the provided questions. Product database 113 is a relational database which associates each scanned barcode with a particular product. Question database associates each barcode contained within product database 115 with a specific set of questions for each product or user.

Alternatively, the questions stored in product database 115 may be user or time specific. For example, the additional questions may be altered based on the particular user's age, sex, occupation, or other information stored in the user database. The questions may even be altered based upon the time of day, day of the week, month, etc. By altering the question in such a manner, the behavior monitoring system of the present invention may appear more interactive to the user and thus encourage further user participation.

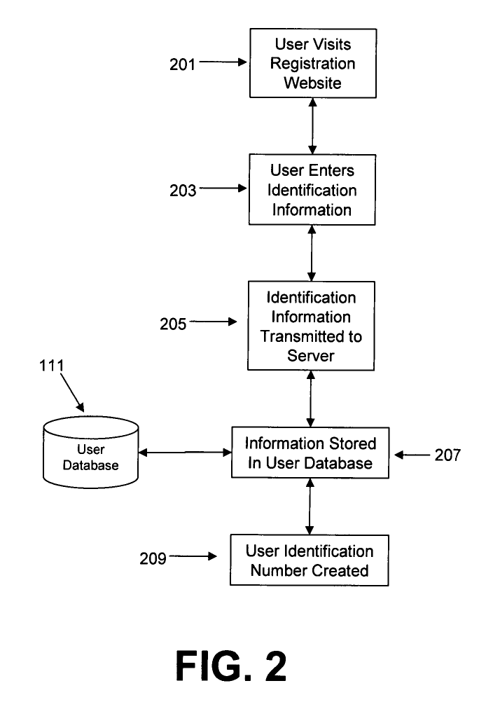

Now with reference to FIG. 2, shown is a flowchart which depicts the registration of a user via a website. First, the user visits the registration website using an Internet browser in step 201. The website contains a registration form which the user must complete in order to participate in the behavior monitoring system. The user enters the identification information requested by the form in step 203. The identification information may include, but is not limited to, a first name, last name, social security number, address, telephone number, birth date, age, occupation, education, preferred method of contact, etc.

Once all of the information has been entered by the user, this information is then sent to server 109 via wireless network 107 in step 205. Server 109 then creates a new account for the user and stores the received identification information in step 207. In the preferred embodiment, the information is stored in user database 111. The new user account is assigned a unique identification number in step 209. This number is utilized by the behavior monitoring system whenever information about a particular user is requested for any purpose.

A user may also register by filling out a printed questionnaire and submitting it to the company in charge of the behavior monitoring system. The questionnaire would ask the user to provide the same information requested by the website. Once the form is received by the company, the information from each user can be manually entered or scanned into user database 111.

Participants can also register with the system of the present invention utilizing the telephone. In this method of registration, each user would be provided with a local or toll-free telephone number to call for registration. The telephone registration system may use an interactive voice response system to have a participant provide identification information. The user could either utilize the telephone keypad to enter information or the user could speak each entry.

Telephone registration may also be accomplished utilizing a live operator who asks the participant each question and manually enters the information into user database 111.

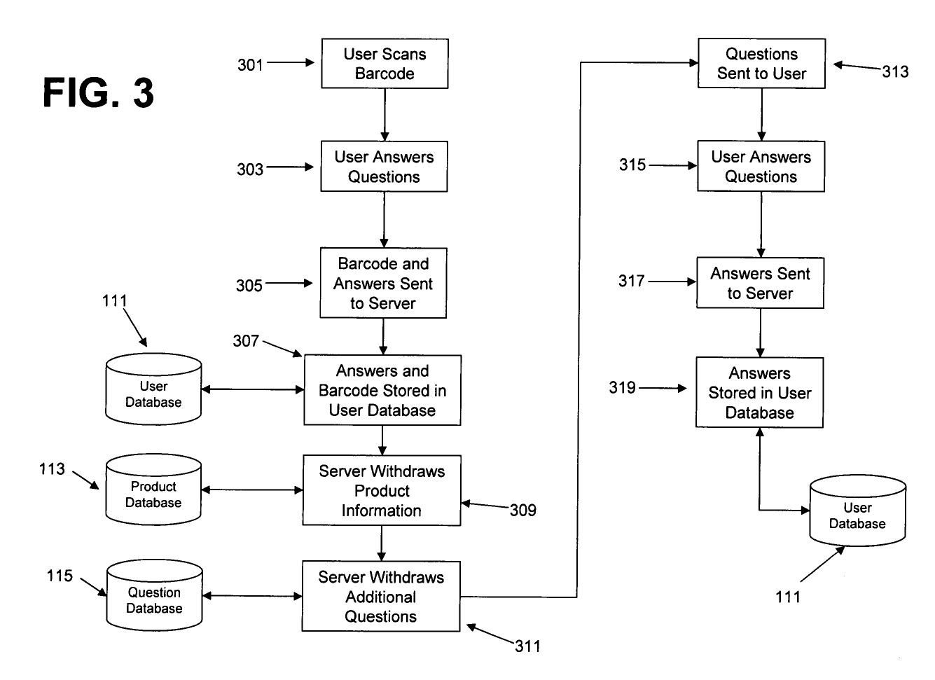

Now with reference to FIG. 3, shown is a flowchart depicting the steps performed by the system of the present invention each time a barcode is scanned by a user. The user first scans the barcode utilizing mobile device 105 in step 301. As previously mentioned, this may be accomplished with either a laser-based scanning device or using a mobile device equipped with a digital camera. Since mobile device 105 is wireless, the user may utilize it to scan products at a wide variety of locations. For example, the user may utilize mobile device 105 to scan products at a supermarket, retail outlet, office supply store, etc. The usability of mobile device 105 is only limited by the range of wireless network 107. However, mobile device 105 may even operate in absence of wireless network 105 for a brief period of time by storing the scanned barcodes and user answer's in its internal memory.

After the user scans the barcode, a program located on mobile device 105 prompts the user to answer a series of questions pertaining to the item scanned in step 303. Generally, these questions are generic such as “Quantity purchased?” and are not specific to the item scanned.

Mobile device 105 then transmits the user's identification number, the scanned machine readable code, and the question answers are then sent to server 109 via wireless network 107 in step 305. The question answers along with the scanned barcode are stored with the user's profile in user database 111 in step 307. Next, server 109 utilizes product database 113 to associate the machine readable code with a particular product in step 309. The product information, along with the user's identification information, is then used to look up additional questions in question database 115 pertaining to the scanned product in step 311. Unlike the first series of questions answered by the user in step 303, the questions stored in question database 115 are more specifically tailored to the product scanned and the user.

The additional questions from question database 115 are transmitted to mobile device 105 via wireless network 107 in step 313. The user then answers these questions in step 315 and the answers are transmitted back to server 109 via wireless network 107 in step 317. The additional answers are stored in user database 111 in step 319.

The process described in steps 301 through 319 takes a minimal amount of time and the stored question answers and barcode information are provided in real-time for analysis. Such a system provides the company utilizing the system of the present invention with valuable marketing information about a user's purchasing behavior. Since the users' answers are stored in real-time in user database 111, the company has immediate access to this marketing information such as product purchased, quantity, price, place, etc.

While the foregoing embodiments of the invention have been set forth in considerable detail for the purposes of making a complete disclosure, it should be evident to one skilled in the art that multiple changes may be made to the aforementioned description without departing from the spirit of the invention.

1. A method of tracking consumer behavior comprising the steps of:
scanning at least one machine readable code located on one or more items of commerce using a mobile device;
providing questions to a user about said item of commerce;
receiving answers to said questions from said user;
transmitting said machine readable code information and said question answers to a server via a wireless network; and
storing said machine readable code and said question answers in a user database located on said server.

2. A method of monitoring consumer behavior according to claim 1, further comprising the steps of:
querying a question database to obtain additional questions related to said item of commerce;
transmitting said additional questions from said server to said mobile device via said wireless network;
receiving answers to said additional questions; and
transmitting said answers to said additional questions from said mobile device to said server; and
storing said answers to said additional questions in said user database.

3. A method of monitoring consumer behavior according to claim 1, wherein said mobile device is from the list comprising of a camera phone, a personal digital assistant, and a laser-based scanning device.

4. A method of monitoring consumer behavior according to claim 1, wherein said wireless network is a cellular network.

5. A method of monitoring consumer behavior according to claim 2, wherein said additional questions are determined by at least one from the list comprising of, but not limited to, said item of commerce, said user's age, said user's sex, said user's location, said user's profession, the time of day, the day of the week, the month, and the year.

6. A method of monitoring consumer behavior according to claim 1, wherein the personal information of each user is stored in said user database.

7. A system for monitoring consumer behavior comprising:
at least one machine readable code located on an item of commerce;
at least one mobile device capable of scanning machine readable codes, wherein said mobile device provides questions to a user after scanning a machine readable code;
a server containing a plurality of databases;
a wireless network for transmitting said machine readable code and answers to said questions to said server; and
a user database located on said server for storing said machine readable code and said answers to said questions.

8. A system of for monitoring consumer behavior according to claim 7, further comprising a question database located on said server for storing additional questions related to said machine readable code wherein said additional questions are transmitted to said mobile device upon reception of said machine readable code from said mobile device.

9. A system of for monitoring consumer behavior according to claim 7, further comprising a question database located on said server for storing additional questions related to said machine readable code.

10. A system for monitoring consumer behavior according to claim 7, wherein said mobile device is from the group comprising a camera phone, a personal digital assistant, and a laser-based scanning device.

11. A system for monitoring consumer behavior according to claim 7, wherein said wireless network is a cellular network.

12. A system for monitoring consumer behavior according to claim 7, wherein said server contains a product database which associates a plurality of machine readable codes with a plurality of articles of commerce.

13. A system for monitoring consumer behavior according to claim 7, wherein said machine readable code is a barcode.

14. A system for monitoring consumer behavior according to claim 7, wherein said machine readable code is an RFID tag.

15. A system for monitoring consumer behavior according to claim 13, wherein said barcode wherein said barcode is constructed from at least one of the standardized barcode symbology libraries consisting of the group of UPC-A, UC-E, ISBN, RSS-14, RSS-14E, RSS-14L, Interleaved 2 of 5, EAN/JAN-8, EAN/JAN-13, Code 3, Code 39 Full ASCII, Code 128, PDF417, QR Code, or Data Matrix.
